(19) United States
(12) Patent Application Publication
(10) Pub. No.: US 2011/0248011 A1
(43) Pub. Date: Oct. 13, 2011

(54) MANUFACTURE OF WELDED COMPONENTS

(75) Inventor: Dorival Tecco, Cambridge (GB)

(73) Assignee: WELDING ALLOYS LIMITED, Hertfordshire (GB)

(21) Appl. No.: 12/673,085

(22) PCT Filed: Aug. 29, 2008
(86) PCT No.: PCT/GB2008/002922

§ 371 Date: Jun. 27, 2011

(30) Foreign Application Priority Data
Aug. 30, 2007 (GB) GB0716729.9

(51) Int. Cl. B23K 9/00; B07B 13/00; B23C 1/00

(52) U.S. Cl. 219/136; 409/64; 209/509

(57) ABSTRACT

An apparatus and method for the manufacture of welded components, the apparatus comprising welding means (100) at the welding location, means for supporting a substrate (104) to be welded by the welding means (100) at the welding location and machining means (102) arranged to machine the surface of a so-welded component; the apparatus characterised by including: a debris sorter comprising a debris collector (106) for receiving, when in use, machined debris from the surface of a welded component, the debris collector (106) being connected to a debris separator (110) for separating the machined debris by type into at least a first outlet path A and a second outlet path B.

The present invention relates, in general, to fusion processes used to improve the characteristics of certain types of materials. In particular, the present invention relates to metallic components which are welded.

For simplicity in this application, any references to “welding” imply “welding, cladding, hardfacing, brazing and/or soldering”, and any references to “welded” imply “welded, clad, hardfaced, brazed and/or soldered”.

The manufacture of welded rollers, plates and similar metal products provides components which are used in harsh and demanding working environments where resistance to abrasion, adhesion, erosion, cavitation, oxidation and/or corrosion is important and which comprise a metallic base or substrate that is welded on one or more of its surface. Such a substrate may be a steel, low-alloy ferrous material, iron or high-alloy ferrous material, cobalt-based alloy, nickel-based alloy or a copper-based alloy.

Throughout this specification, the word “manufacture” is used in respect of not only the primary production of welded rollers, plates and other similar metal components but also the refurbishment of such components.

A typical technique for manufacturing welded rollers involves an arc welding operation to the outer surface of a comparatively inexpensive and less durable cylindrical metal substrate which after such welding is demounted from the welding apparatus and is transported to remote machinery apparatus where the now welded surface is machined, for example, by milling, to provide a welded surface of a predetermined depth and, hence, a welded roller of a predetermined diameter, as well as of a desired smoothness.

In WO 2007/028990, the contents of which are hereby incorporated by reference, the applicant of the present invention discloses an apparatus and method for use in the manufacture of hardfaced, clad metal substrates comprising welding means at a cladding location, means for supporting a substrate to be metal clad by the welding means at the cladding location and means arranged to machine the surface of a so-clad substrate at the cladding location.

FIG. 1 illustrates an apparatus according to the prior art used for manufacturing a welded roller (not shown) for use in a steel rolling plant. The apparatus comprises four main components at a cladding location 100, namely:
a) a device similar to a lathe and indicated generally at 2 for rotatably supporting a metal cylinder (not shown), as a substrate, to be welded with a metal by arc welding;
b) an arc welding device indicated generally at 3 for welding the surface of the metal cylinder with metal;
c) a device indicated generally at 4 for machining the welded surface of the cylinder; and
d) a laser device indicated generally at 5 for monitoring the welded component and/or the unwelded surface of the cylinder.

The apparatus 1 comprises a bed 6 upon which the devices 2 to 5 are mounted at the welding location 100. The lathe-type device 2 comprises a headstock 21 mounted rotatably in conventional manner to a drive unit 23 which is fixed with respect to the bed 6. A tailstock 22 is mounted rotatably to another unit 24 which is mounted upon bed rails 25 for linear movement towards and away from the drive unit 23 and associated headstock 21, again in known manner.

The axially opposed ends of a metal cylinder (not shown) to be welded can be mounted to respective ones of the headstock 21 and tailstock 22 for rotation with respect to the arc welding device 3 about an axis generally perpendicular to the longitudinal axis of the arc welding gun of the device 3.

Use of the apparatus 1 as described above provides a means to provide a fusion process applied to materials, in particular, to metallic components which are welded.

One requirement of providing a substrate for machining or processing down to a required dimension or smoothness is that an excess amount of the material to be machined must be deposited on the component to be machined.

Once the excess material has been machined away from the surface of the component it is typically collected and disposed of in a landfill or transferred to scrap yards or sent for re-melting. The excess material can be a significant proportion of the total material deposited making the process inefficient. Further, the sharpness and composition of the excess material means that disposal can be costly in financial terms and provide a significant health and safety concern for users.

### SUMMARY OF THE INVENTION

According to a first aspect of the present invention, there is provided an apparatus for use in the manufacture of welded components, comprising welding means at the welding location, means for supporting a component to be welded by the welding means at the welding location and machining means arranged to machine the surface of a so-welded component; the apparatus characterised by including: a debris sorter comprising a debris collector for receiving, when in use, machined debris from the surface of a welded component, the debris collector being connected to a debris separator for separating the machined debris by type into at least a first outlet path and a second outlet path

Accordingly the present invention allows for the collection and processing of the excess metal for subsequent use.

Preferably, the first outlet path is a feedback path connected to an input at the welding location or connected to a storage unit. The excess metal can therefore be stored and, in the case of welding, recirculated into the fusion process. Advantageously, the recirculated excess metal has a composition matched to the required metal at the welding location.

Preferably, a crushing means is disposed in the first outlet path. A crushing means permits the excess metal to be processed into a preferred size for efficient reuse and/or storage.

Preferably, the debris separator is configured to separate a metal from the remainder of the machined debris.

Preferably, the debris separator is a magnetic device. A magnetic device is preferred where the machined debris has magnetic properties. A magnetic device may be provided as a coil.

Preferably, the first and/or second outlet paths comprise a conveyor belt and the first and second outlet paths are offset in height relative to one and another. Where the first outlet path is, when in use, disposed above the second outlet path and the first outlet path does not overlap the second outlet path the second outlet path may optionally be a free-fall outlet path to a waste unit. Advantageously, the debris separator is located in the free-fall outlet path.

In order to provide a smooth and efficiently run apparatus, the machined debris is preferably continuously sorted by the debris sorter and continuously fed back to the input at the cladding location.

According to a second aspect of the present invention, there is provided a welded component machining apparatus comprising machining means arranged to machine the surface of a welded component; the apparatus characterised by including: a debris sorter comprising a debris collector for receiving, when in use, machined debris from the surface of a welded component, the debris collector being connected to a debris separator for separating the machined debris by type into at least a first outlet path and a second outlet path.

In the second aspect of the present invention, the machining means is not located at the same location as the welding means.

According to a third aspect of the present invention, there is provided a welded substrate debris sorter comprising a debris collector for receiving, when in use, machined debris from the surface of a welded component, the debris collector being connected to a debris separator for separating the machined debris by type into at least a first outlet path and a second outlet path.

In the third aspect of the present invention, the debris sorter is provided independently of a machining and welding means.

According to a fourth aspect of the present invention, there is provided a method of manufacturing and machining a welded component, the method comprising welding a surface of a component and then machining the so-welded component; the method characterised by including: collecting machined debris resulting from the machining of the component, and separating the machined debris by type into at least a first outlet path and a second outlet path.

Preferably, the method comprises feeding-back via the first outlet path one type of separated machined debris for use in the step of welding the component.

Preferably, the separating of the machined debris and the feeding-back of separated machined debris is carried out continuously.

Preferably, the method comprises storing via the first outlet path one type of separated machined debris for subsequent use in the step of welding the component and optionally crushing the machined debris prior to feeding-back or storing the one type of separated machined debris.

Preferably, the step of storing or feeding-back is carried out continuously whilst the step of welding and machining is carried out.

### BRIEF DESCRIPTION OF THE DRAWINGS

Embodiments of the present invention will now be described, by way of example only, and with reference to the accompanying drawings in which:

FIG. 1 is a front elevational view of a welded roller manufacturing apparatus according to the prior art;

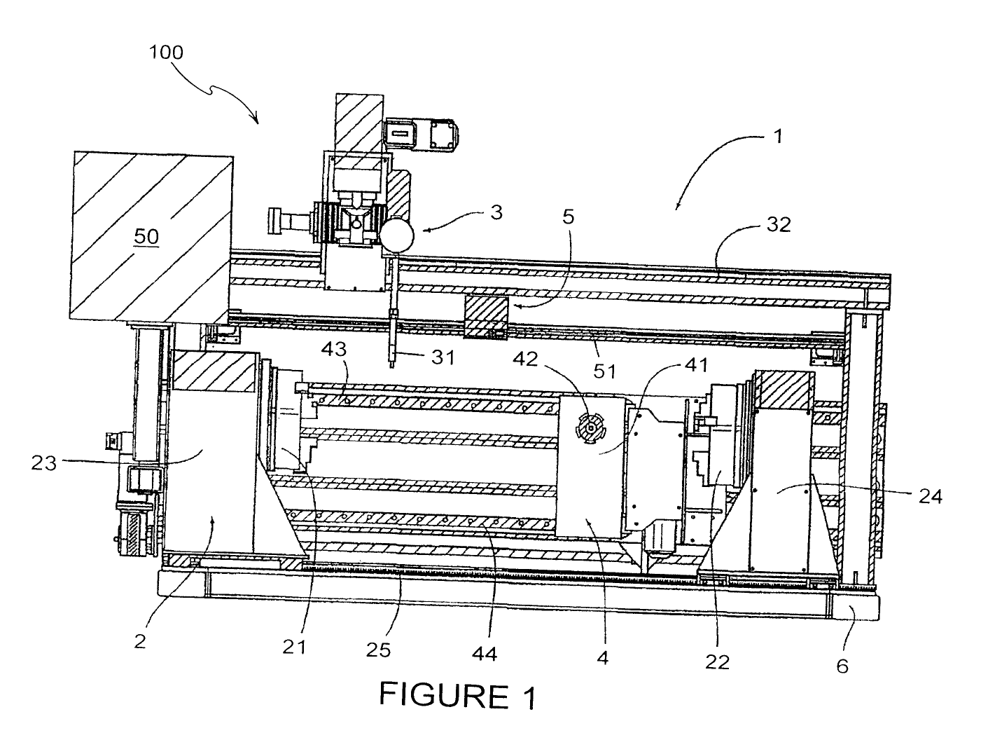

FIG. 2 is a schematic diagram of a welding apparatus according to a first embodiment of the present invention;

FIG. 3 is a schematic flow diagram according to a second embodiment of the present invention; and

FIG. 4 is a schematic flow diagram according to a third embodiment of the present invention.

### DETAILED DESCRIPTION

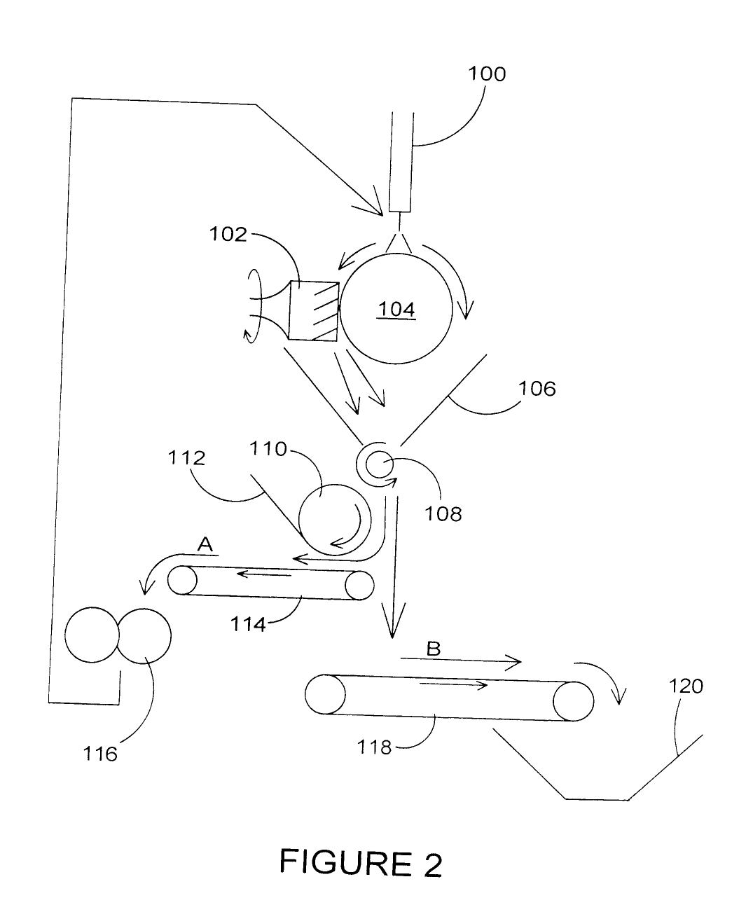

Referring to FIG. 2, a welding apparatus according to a first embodiment of the present invention comprises a welding device 100; a milling head 102; a component 104 to be welded; a hopper 106; a first conveyor 108; a magnetic device 110; a scraper 112; a second conveyor 114; a crushing means 116; a third conveyor 118 and a waste unit 120.

In operation, the milling head 102 machines off material which has been applied to the surface of the component 104 through welding by a fusion process such as electron-beam, arc-welding or laser fusion.

The material applied to the surface of the component 104 in the case of arc-welding can be a mixture of slag, flux and a weld metal such as a steel, low-alloy ferrous material, iron or a high-alloy ferrous material or a cobalt, nickel or copper-based alloy. During machining of the component 104, debris in the form of metallic shavings is ejected from the surface of the component 104. Such debris may also include traces of flux and slag.

The debris is collected in the hopper 106 and fed by the first conveyor 108 to a magnetic device 110. In the present embodiment, a magnetic device 110 is preferred as a debris separator because a metallic material having magnetic properties is used. However, the particular debris separator is chosen having regard to the composition of the debris requiring separation. The debris separator is therefore interchangeable and according to the composition of the debris requiring separation different debris separators can be selected.

The magnetic device 110 attracts metallic debris along a first outlet path A and a scraper 112 releases the metallic debris from the magnetic device and onto a second conveyor 114. The second conveyor 114 conveys the metallic debris to a crushing means 116 which crushes the metallic debris into particles of a size suitable for reuse as, for example, as a filler metal for welding or as a filler that is added to the flux for welding. The crushed and sorted metallic debris can be recycled back to the fusion process stage as illustrated in FIG. 2 or stored for subsequent use.

The debris not attracted by the magnetic device 110 falls towards a third conveyor 118 along a second outlet path B. The third conveyor 118 conveys the debris to a waste unit because the composition of the debris in the second outlet path is substantially non-metallic waste materials such as slag.

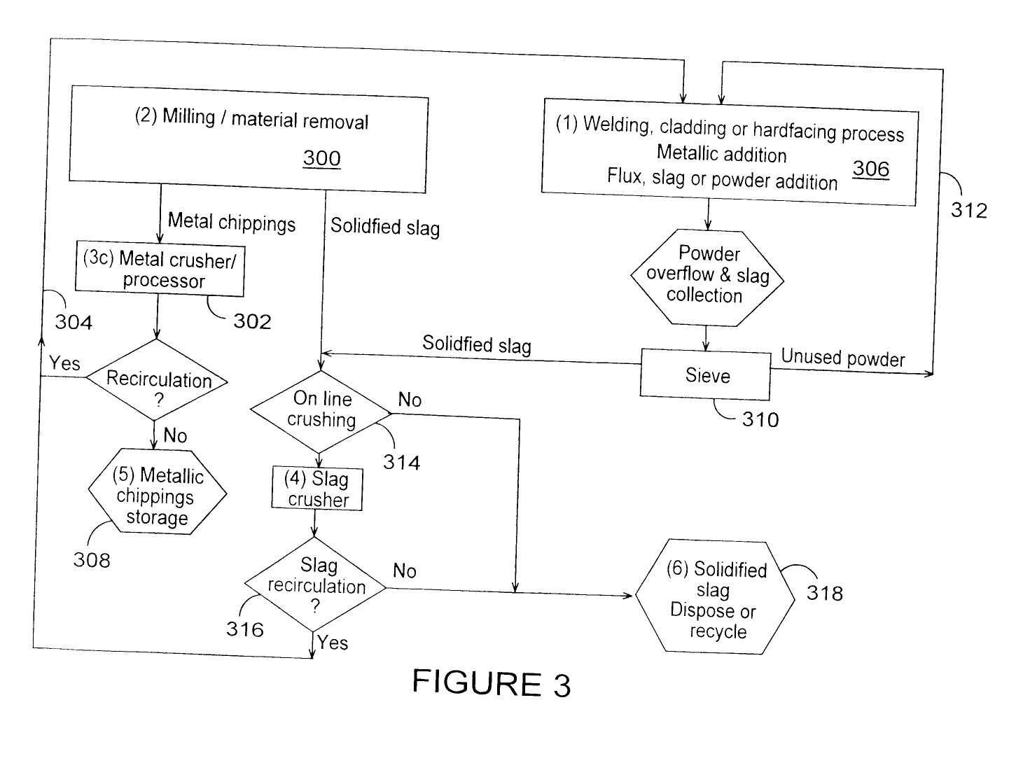

As shown above with reference to FIG. 2, a milling head 102 machines off reinforcement simultaneously with welding of a component 104. The subsequent separation between the metallic debris and slag may be achieved directly or indirectly as discussed below with reference to FIGS. 3 to 5. Further, the milling head 102 may be operated separately from or remote from the welding process.

Referring to FIG. 3, a schematic flow diagram according to a second embodiment of the present invention illustrates direct metal separation after machining where the steps of machining and welding are performed simultaneously.

Following a machining step 300, the metallic debris is subject to a debris crushing step 302 by a crushing means (not shown in FIG. 3). Following the crushing step 302 the metallic debris can be either recirculated in a recirculating step 304 to a fusion process step 306 or to a storage step 308 for later use.

If the metallic debris is stored for subsequent use in the welding process it can be processed further by additional processing steps. Such additional processing steps can include crushing steps or further processing steps.

Additionally, slag and flux used in the welding process step 306 can be collected and separated in a flux and slag separating step 310. For the flux and slag separating step 310 a sieve may be used to collect large used particulate flux and solidified slag whereas unused powered flux may be collected and recirculated back in a flux recirculating step 312 to the fusion process.

The solidified slag is optionally crushed at a solidified slag crushing step 314 and recirculated 316 into the welding process 306 or collected 318 for disposal or subsequent reuse.

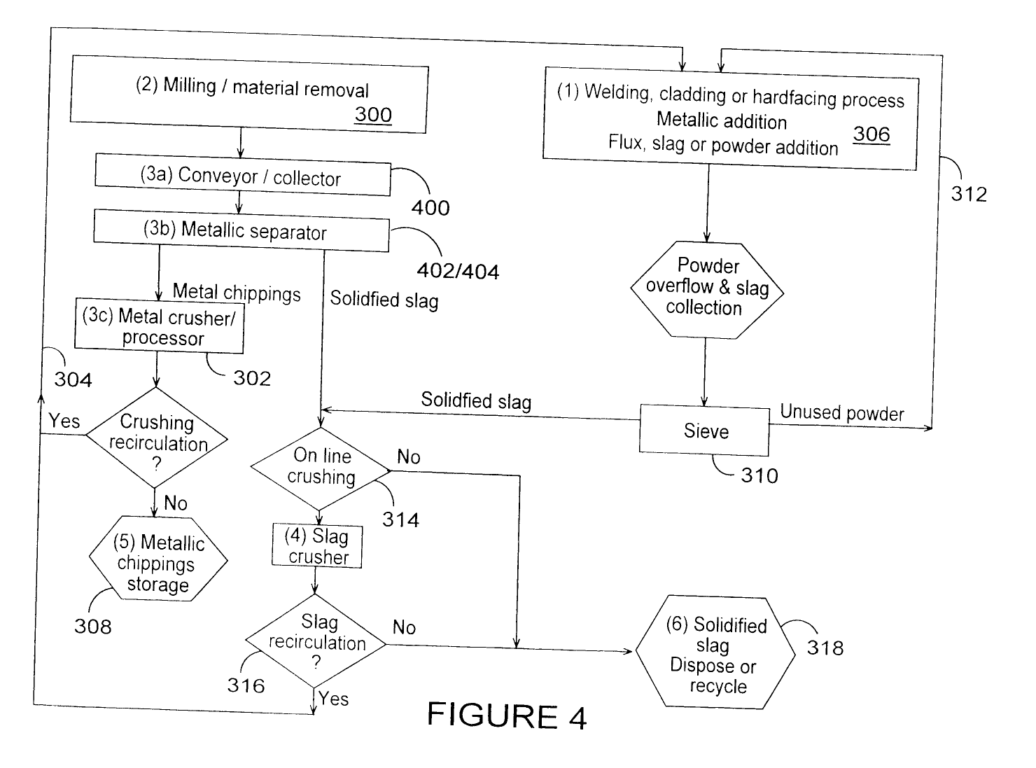

Referring to FIG. 4, a schematic flow diagram according to a third embodiment of the present invention illustrates indirect metal separation after machining where the steps of machining and welding may or may not be performed simultaneously.

In FIG. 4, like process steps as described and illustrated having regard to FIG. 3 have been given like reference numbers.

Following the machining step 300, the metallic debris is subject to a first conveyor step 400 and a debris sorting step comprising a debris collector for receiving, when in use, metallic debris from the surface of a welded component. The metallic debris is subjected to a separating step 404 using, for example a magnetic device 110 as described in connection with FIG. 2. The metallic debris is subject to the debris crushing step 302 by a crushing means (not shown in FIG. 3). Following the crushing step 302 the metallic debris can be either recirculated in a recirculating step 304 to a welding process step 306 or to a storage step 308 for later use.

Additionally, slag and flux used in the welding process step 306 can be collected and separated in a flux and slag separating step 310. For the flux and slag separating step 310 a sieve may be used to collect large used particulate flux and solidified slag whereas unused powered flux may be collected and recirculated back in a flux recirculating step 312 to the welding process.

The solidified slag is optionally crushed at a solidified slag crushing step 314 and recirculated 316 into the welding process 306 or collected 318 for disposal or subsequent reuse.

No doubt many other effective alternatives will occur to the skilled person. It will be understood that the invention is not limited to the described embodiments and encompasses modifications apparent to those skilled in the art lying within the spirit and scope of the claims appended hereto.

1. Apparatus for use in the manufacture of welded components, comprising welding means at the welding location, means for supporting a substrate to be welded by the welding means at the welding location and machining means arranged to machine the surface of a so-welded component; the apparatus characterised by including: a debris sorter comprising a debris collector for receiving, when in use, machined debris from the surface of a welded component, the debris collector being connected to a debris separator for separating the machined debris by type into at least a first outlet path and a second outlet path.

2. An apparatus as claimed in claim 1, wherein the first outlet path is a feedback path connected to an input at the welding location.

3. An apparatus as claimed in claim 1, wherein the first outlet path is connected to a storage unit.

4. An apparatus as claimed in claim 1, wherein a crushing means is disposed in the first outlet path.

5. An apparatus as claimed in claim 1, wherein the debris separator is configured to separate a metal from the remainder of the machined debris.

6. An apparatus as claimed in claim 1 wherein the debris separator is a magnetic device.

7. An apparatus as claimed in claim 6, wherein the magnetic device is a coil.

8. An apparatus as claimed in claim 1, wherein the first and/or second outlet paths comprise a conveyor belt.

9. An apparatus as claimed in claim 1, wherein the first and second outlet paths are offset in height relative to one and another.

10. An apparatus as claimed in claim 9, wherein the first outlet path is, when in use, disposed above the second outlet path.

11. An apparatus as claimed in claim 1, wherein the first outlet path does not overlap the second outlet path.

12. An apparatus as claimed in claim 1, wherein the second outlet path is a free-fall outlet path to a waste unit.

13. An apparatus as claimed in claim 12, wherein the debris separator is located in the free-fall outlet path.

14. An apparatus as claimed in claim 1, wherein the debris collector is a hopper.

15. An apparatus as claimed in claim 1, wherein the welding means in an arc welding gun.

16. An apparatus as claimed in claim 2, wherein, in use, the machined debris is continuously sorted by the debris sorter and continuously fed back to the input at the welding location.

17. A welded component machining apparatus comprising machining means arranged to machine the surface of a welded component; the apparatus characterised by including: a debris sorter comprising a debris collector for receiving, when in use, machined debris from the surface of a welded component, the debris collector being connected to a debris separator for separating the machined debris by type into at least a first outlet path and a second outlet path.

18. A welded component debris sorter comprising a debris collector for receiving, when in use, machined debris from the surface of a welded component, the debris collector being connected to a debris separator for separating the machined debris by type into at least a first outlet path and a second outlet path.

19. A method of manufacturing and machining a welded component, the method comprising welding a surface of a component and then machining the so-welded component; the method characterised by including:
collecting machined debris resulting from the machining of the component, and separating the machined debris by type into at least a first outlet path and a second outlet path.

20. A method as claimed in claim 19 comprising feeding-back via the first outlet path one type of separated machined debris for use in the step of welding a component.

21. A method as claimed in claim 20, wherein the separating of the machined debris and the feeding-back of the separated machined debris is carried out continuously.

22. A method as claimed in claim 19 comprising storing via the first outlet path one type of separated machined debris for subsequent use in the step of welding a component.

23. A method as claimed in claim 20 comprising a step of crushing the machined debris prior to feeding-back or storing the one type of separated machined debris.

24. A method as claimed in claim 19 wherein the separating is carried out magnetically.

25. A method as claimed in claim 20 wherein the step of storing or feeding-back is carried out continuously whilst the step of welding and machining is carried out.

26. A method as claimed in claim 19 comprising conveying the separated machined debris along the first outlet path and/or the second outlet path.

27. A method as claimed in claim 19 wherein machining of the welded component is performed by a milling or laithing operation.

28. A method as claimed in claim 19 wherein welding is carried out by means of a welding gun.

29. A method as claimed in claim 19 wherein the second outlet path comprises a free falling path to a waste unit.

30. A method as claimed in claim 19 wherein the machining of the so-welded component is carried at the location of the welding operation.

31. (canceled)

32. (canceled)
